(19) United States
(12) Patent Application Publication
(10) Pub. No.: US 2003/0056195 A1
(43) Pub. Date: Mar. 20, 2003

(54) Code generator

(76) Inventor: Joseph R. Hunt, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/909,058

(22) Filed: Jul. 19, 2001

(51) Int. Cl. G06F 9/44

(52) U.S. Cl. 717/116

(57) ABSTRACT

A method and apparatus of automating generation of object oriented code for an object. A common object repository stores a library of interrelated objects for reuse in a large software system. An object is defined by a user entering meta data defining the object and the object's relationships with objects stored in the common object repository. Source code is created from the meta data, wherein the source code defines the object and the object's relationships. A definition is created for the storage of an instantiation of the object using the meta data, and this definition is stored in a relational database table stored as a part of the common object repository. When an object is to be instantiated, the source code is used and the instantiation of the object is stored in the common object repository.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### FIELD OF THE INVENTION

This invention relates generally to the field of computer programs, methods and systems that automatically generate computer code (referred to herein as a code generator or code builder program, tool or application). More particularly, the preferred embodiment of the present invention relates to a computer program, method and system for generating computer code to program objects, interfaces, factories and their relational schema using languages such as C++ and SQL.

### BACKGROUND OF THE INVENTION

Today's sophisticated software systems using relational databases and object oriented programming techniques are capable of producing very systematic, easily documented reusable code. This has proven to be a boon to the economics of software generation and maintenance. However, when software systems become very complex (i.e., having multiple inheritances and deep chains of inheritance), other problems often surface. Generation, maintenance and debugging of such code can be tedious, time consuming and subject to error.

When edits and changes are required, the code for many files may require edits. Often a single seemingly simple interface change will require the developer to update many files. For example a change to the parameter list of a common interface in a complex object model (e.g., 25 objects or more), may require the engineer to edit 100 files or more. Not only is this tedious, it is also very prone to error for large software systems. Errors are common when all files are inadvertently not updated or when typographical errors are introduced in the updating process.

### BRIEF SUMMARY OF THE INVENTION

The present invention relates generally to a method and apparatus for generation of object oriented computer code. Objects, advantages and features of the invention will become apparent to those skilled in the art upon consideration of the following detailed description of the invention.

In one embodiment consistent with certain aspects of the present invention, a method and apparatus of automating generation of object oriented code for an object is provided. A common object repository stores a library of interrelated objects for reuse in a large software system. An object is defined by a user entering meta data defining the object and the object's relationships with objects stored in the common object repository. Source code is created from the meta data, wherein the source code defines the object and the object's relationships. A definition is created for the storage of an instantiation of the object using the meta data, and this definition is stored in a relational database table stored as a part of the common object repository. When an object is to be instantiated, the source code is used and the instantiation of the object is stored in the common object repository.

In one method consistent with an embodiment of the present invention, a method of automating generation of object oriented code includes: receiving meta data defining an object and the object's relationships; creating source code from the meta data, the source code defining the object and the object's relationships; creating a storage definition for the storage of an instantiation of the object using the meta data; and storing the storage definition in a common object repository.

In another embodiment consistent with the present invention, a method of automating generation of object oriented code for an object includes: providing a common object repository storing a library of interrelated objects; receiving meta data defining an object and the object's relationships with objects stored in the common object repository; creating source code from the meta data, the source code defining the object and the object's relationships; creating a definition for the storage of an instantiation of the object using the meta data; and storing the storage definition in the common object repository.

An electronic storage medium consistent with embodiments of the invention can store instructions that, when executed, carry out the above methods.

A computer system consistent with an embodiment of the invention has a programmed processor and storage that stores a common object repository containing a library of interrelated objects. A user interface receives meta data defining an object and the object's relationships with objects stored in the common object repository. A program segment, running on the programmed processor, functions to: create source code from the meta data, the source code defining the object and the object's relationships; create a definition for the storage of an instantiation of the object using the meta data; and store the storage definition in the common object repository.

In preferred embodiments of the computer system above, the program segment further functions to: instantiate the object using the source code; and store the instantiation of the object in the common object repository. Moreover, the computer system above, further has a relational database operating on the programmed processor, wherein the meta data and other information is stored in relational database tables.

Many variations, equivalents and permutations of these illustrative exemplary embodiments of the invention will occur to those skilled in the art upon consideration of the description that follows. The particular examples above should not be considered to define the scope of the invention.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is an illustration describing a flow of files that are created by the code generator according to an embodiment of the present invention.

FIG. 2 is an illustration of one dialog of a graphical user interface that defines meta data that describes an interface consistent with an embodiment of the present invention.

FIG. 3 is an illustration of a dialog of a graphical user interface for adding a class member consistent with an embodiment of the present invention.

FIG. 4 is an illustration of a dialog of a graphical user interface for adding a class method consistent with an embodiment of the present invention.

FIG. 5 is an illustration of a dialog of a graphical user interface for further specifying interfaces consistent with an embodiment of the present invention.

FIG. 6 is an illustration of a dialog of a graphical user interface for adding interfaces consistent with an embodiment of the present invention.

FIG. 7 is an illustration of the program operation of instantiation of the various dialogs corresponding to the dialogs of the GUI of an embodiment of the present invention.

FIG. 8 is a flow chart describing the sequence of user interaction according to an embodiment consistent with the present invention.

FIG. 9 is a flow chart describing a process for source code file creation according to an embodiment consistent with the present invention.

FIG. 10 is a flow chart describing a process for interface file creation according to an embodiment consistent with the present invention.

FIG. 11 is a flow chart describing a process for data object header file creation according to an embodiment consistent with the present invention.

FIG. 12 is a flow chart describing a process for data object implementation file creation according to an embodiment consistent with the present invention.

FIG. 13 is a flow chart describing a process for package file creation according to an embodiment consistent with the present invention.

FIG. 14 is a flow chart describing a process for component header file creation according to an embodiment consistent with the present invention.

FIG. 15 is a flow chart describing a process for component implementation file creation according to an embodiment consistent with the present invention.

FIG. 16 is a flow chart describing a process for factory header file creation according to an embodiment consistent with the present invention.

FIG. 17 is a flow chart describing a process for factory file creation according to an embodiment consistent with the present invention.

FIG. 18 is a flow chart describing creating an SQL Table File according to an embodiment consistent with the present invention.

FIG. 19 is a flow chart describing creating an SQL Table Removal File according to an embodiment consistent with the present invention.

FIG. 20 is a flow chart describing creating an SQL View File according to an embodiment consistent with the present invention.

FIG. 21 is a flow chart describing creating an SQL View Removal File according to an embodiment consistent with the present invention.

FIG. 22 is a block diagram of a computer system suitable for running the code builder application according to an embodiment consistent with the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

While the present invention illustrates certain preferred embodiments of the invention, those skilled in the art will understand that the exact interface illustrated and process described can be varied substantially without departing from the invention. The code generator according to certain embodiments of the invention allows the user to enter simple “meta” data that describes the interface of the object desired. The exact data required can vary from system to system without departing from the present invention.

In the current embodiment, the meta data used is as follows:

The meta data for each class calls out the following information: base class, class members, methods and interfaces.

For each class member, the meta data defines the member name, member type and whether or not a “Set” function and a “Get” function are to be associated with the class member.

For each class method, the meta data defines a method name, a return type, a method parameter list, a method description and a default implementation.

For each interface, the meta data includes an interface description, forward declarations and “include” statements, and defines whether or not the interface should generate a component for the class, and whether or not it is an extension of a library of interrelated objects referred to herein as a common object repository (or “core”) as will be described later in more detail.

For each object class (sometimes referred to a “component”) the meta data further defines interfaces associated with the object class.

In other embodiments consistent with the present invention, the meta data may be more or less inclusive of the above without departing from the invention.

Once the user has entered the meta data, it is stored, according to preferred embodiments of the present invention, in a relational database. Four separate tables are created for storing the meta data, one for classes, one for members, one for methods and one for interfaces. The tables are created, in this embodiment, using the following SQL (Structured Query Language) script designated LISTING 1:

LISTING 1

CREATE TABLE Classes (

| | |
|---|---|
| ClassName VARCHAR(50) | NOT NULL, |
| BaseClass VARCHAR(50) | NULL, |
| InterfaceDescription | VARCHAR (500) NULL, |

| | |
|---|---|
| InterfaceOnly | INTEGER NULL, |
| ForwardDecls | VARCHAR(500) NULL, |
| Extension | INTEGER NULL |

);
CREATE TABLE Members (

| ClassName VARCHAR(50) NOT NULL, | |
|---|---|
| Type VARCHAR(50) | NOT NULL, |
| Name VARCHAR(50) | NOT NULL, |
| makeGet INTEGER | NOT NULL, |
| makeSet INTEGER | NOT NULL |

);
CREATE TABLE Methods (

ClassName VARCHAR(50) NOT NULL,
ReturnValue VARCHAR(50) NOT NULL,
Name VARCHAR(50) NOT NULL,
Parameters VARCHAR(500) NOT NULL,
MethodDescription VARCHAR(500) NOT NULL,
DefaultImplementation VARCHAR NULL

);
CREATE TABLE Interfaces (

| | |
|---|---|
| ClassName VARCHAR(50) | NOT NULL, |
| IfaceName VARCHAR(50) | NOT NULL |

);

The above SQL script is executed once to create tables for storage of the meta data. The meta data is added to the tables whenever the code generator tool is used to input meta data.

The common object repository mentioned above, or “core”, is a library of interrelated objects, object instances, interfaces and methods. Such a common object repository is especially useful in an environment of a large software system that is somewhat dynamic. By way of example, and not limitation, a network management software system might be such an environment. In this environment, new devices (represented as objects) may need to be added to the network at various times. Additionally, new instances of already defined devices may be added frequently. The software may therefore be in a constant state of change, yet require persistent instances of particular objects. To easily interact with such a software system, a common object repository can be used to hold common objects and their interfaces and interrelationships with other objects. In one embodiment compliant with Microsoft Corporation's Windows NT file system, the common object repository can be stored in a shared library such as a DLL file. The actual embodiment of the common object repository may take many forms depending on the particular software environment without departing from the present invention.

Once the meta data is input by the user and the above script creates the tables, the meta data is stored in an SQL compliant relational database. The code generator tool of the present invention then proceeds to create several files of C++ and Structured Query Language (SQL) code (in the preferred embodiment) that can be used to compile and run a database application. The embodiment of the invention described as follows has been found to quickly produce multi-platform compileable code that complies with a standardized coding style, as will be described. It generates not only the objects identified by the meta data, but also creates C++ interface files (in the preferred C++ implementation) as well as object factories. This includes all the ODBC (Open DataBase Connectivity) standard code required to store, refresh and delete the object from an ODBC compliant database. Moreover, the code generation tool generates SQL scripts that describe database tables for storing the objects as well as database views that allow viewing of derived classes across many tables.

In the preferred embodiment, the present code generation tool builds a specific set of C++ classes, SQL tables and View definitions that can be used as the foundation for, or an addition to, a common object repository based on the ODBC (Open Data Base Connectivity) standard. The code generator tool of the preferred embodiment of the present invention is embodied as an application program that presents the user with a Graphical User Interface (GUI) that can be used to easily input meta data about an object model. This meta data is stored in a database that remains persistent across multiple program invocations.

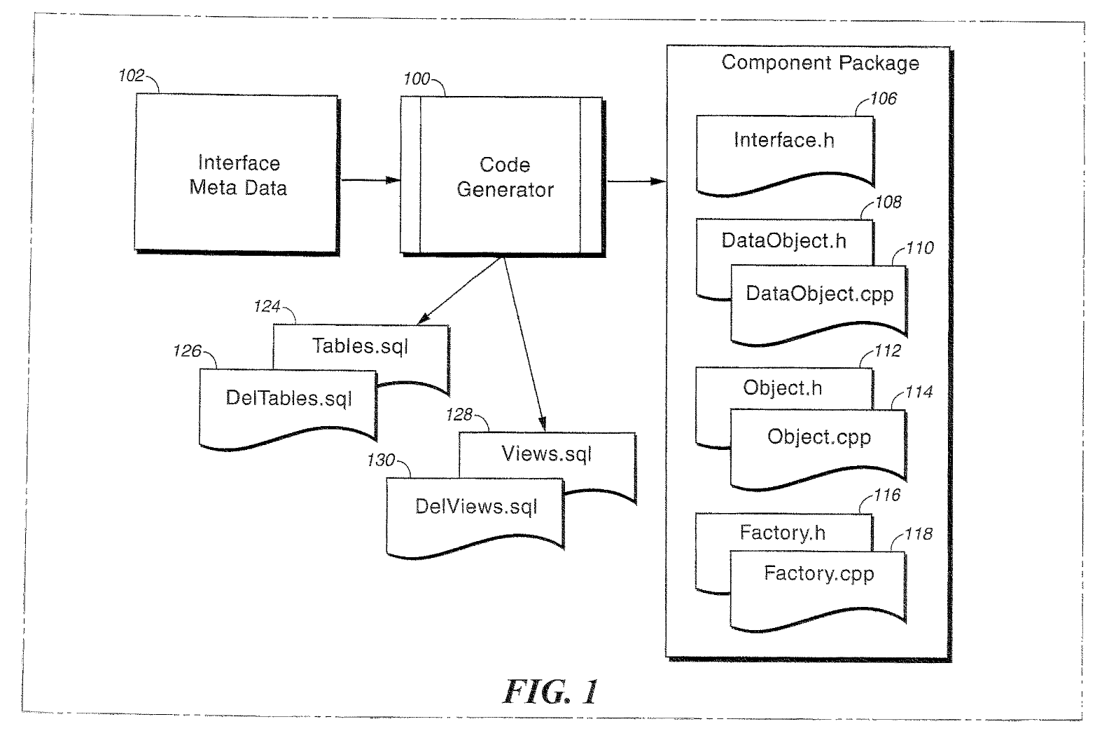

When a change to the object model needs to be made, the user can simply update the meta data through the GUI and regenerate all the files associated with the object model. This is accomplished in the preferred implementation by invoking code to store the meta data in the SQL tables created by the above SQL script and then regenerating the files. Turning now to FIG. 1, by way of an overview, the user of the code generator 100 (an application stored in a suitable electronic storage medium and running on a programmed processor) of the present invention enters meta-data 102 into the code generator 100's GUI. The code generator 100 of the preferred embodiment is hard coded with essential information relating to table naming standards, file naming standards, standard constructors and destructors and other standard fundamental objects. Code generator 100 also is either coded with intimate knowledge of existing files in the common object repository or provided with access to these files and their associated interfaces. This meta-data represents a hierarchy of interfaces that include attributes and operations and is stored in a SQL compliant database in the preferred embodiment. From this data, the current embodiment of the code generator generates the following seven C++ files plus four database SQL files where applicable:

1. A hierarchy of C++ Interface definition files shown as interface.h header files 106;

2. A hierarchy of C++ Data classes, header and implementation files shown as dataobject.h and dataobject.cpp files 108 and 110 respectively. The .h files, as will be appreciated by those skilled in the art, generally defines the structure for the basic class definition, while the .cpp files generally carry the logic to carry out an actual implementation of the function of the object;

3. A Component implementation class (header and implementation files) that is derived from all the required C++ interfaces as well as the C++ Data class shown as object.h and object.cpp files 112 and 114 respectively;

4. A Hierarchy of Component factories (header and implementation files) that create and persist the object. These objects are dynamically loadable and are shown as factory.h and factory.cpp files 116 and 118 respectively (Factories are used as brokers to create new object class instances or to find well known instances. Generally, but not necessarily, there is only one factory object per object class. A factory instance acts as the meta-class for a given implementation and the methods it implements fill the role of static member functions.);

5. SQL scripts to generate and remove RDBMS tables, shown as Tables.sql 124 and DelTables.sql 126, for storage of all Components;

6. SQL scripts to generate and remove RDBMS views, shown as Views.sql 128 and DelViews.sql 130, that join and project all the appropriate Component tables to give a logical representation of Components supporting the same interfaces.

The code generation according to embodiments of the present invention can be implemented in a variety of ways. For example, in one embodiment, the code is generated using a sequence of “print” statements wrapped with appropriate logic using “IF-THEN” decision statements or other appropriate decision statements to generate the needed code. By way of a simple pseudo-code example, suppose the meta data is intended to create an interface only, and as a result of this, a particular action “A” is to be taken. In this example, the logic can be implemented using simple “IF-THEN” statements:

. . .

IF meta data says interface only, THEN take action A

. . .

If action “A” entails creating a string of code that closes a file by a call to a method called “_closefile”, then the pseudo-code might read:

. . .

IF meta data says interface only, THEN _closefile

. . .

In a similar manner, when header files are created, one of the first steps is to generate comments for the header file. This can be readily accomplished by print statements represented by the following pseudo-code:

. . .

Print “/* Copyright 2001, Hewlett-Packard Company.*/“

Print “/* All Rights Reserved. */“

Get Interface_Description from meta data

Print “/* ‘Interface_Description’ */“

. . .

In another embodiment, the code can be implemented by use of merging functions similar to that used for word processing mail merge functions to create the code. In this embodiment, the meta data serves as the variable data merged with a static set of text representing the standard code being created. A particular line of code is only generated if the variable data is present. In either embodiment, the meta data can be stored in a database such as a relational database as previously described. Those skilled in the art will appreciate that other techniques are possible.

In the present invention, the preferred interface model is designed to provide extensibility at the expense of code reuse. Thus, components do not directly inherit interface implementations. Abstraction of components and interfaces creates multiple files with similar content, in many instances. Factories (where a factory is defined as an object that is capable of constructing an instance of a component class) are used for each component. Database mapping is optimized for speed by storing objects in “component” tables within a relational database. Generic queries are implemented using “interface” views that aggregate simplified projections of component tables. Column naming in the tables should follow a systematic syntax to provide for ease of creation of the interface views. Similarly, the objects, interfaces, methods, etc. should follow a systematic naming convention. In one example, the syntax followed for objects, methods, etc. uses the following rules:

Core (Common Object REpository) names and object classes have no prefix or suffix (e.g., ComputerSystem).

Interface names start with “I” (e.g., IComputerSystem).

Implementation class names append “Data” to the name (e.g., ComputerSystemData).

Implementation class functions are prefixed with “_” (e.g., _getName( )).

Object class factories append “Factory” (e.g., ComputerSystemFactory).

Interface Identifiers are prefixed with “IID_” (e.g., IID_IcomputerSystem).

Object class Identifiers are prefixed with “CLSID_” (e.g., CLSID_ComputerSystem).

In this embodiment of the code generation method and apparatus of the present invention, information is input via the GUI (Graphical User Interface) to the code builder application 100 to provide the essential information from an object model. This information includes class inheritance, members, methods, interface description, whether this is a component or an interface and explanatory comments. This meta data are stored in a database such as an SQL compliant relational database such as those commercially available from Solid, 444 Castro Street, Suite 1010, Mountain View, Calif. 94041, www.solidtech.com.

Once the C++ and SQL files are created as illustrated in FIG. 1, the files can be compiled to a binary form to instantiate an object. The compiled binary code for an instantiated object can then be stored in the common object repository along with the SQL Tables and SQL Views of FIG. 1 to provide the reusable repository or library of objects required in the software system. That is, a storage definition for the storage of an instantiation of an object is stored in the common object repository. When objects are instantiated, the instantiation of the object can also be stored to the common object repository.

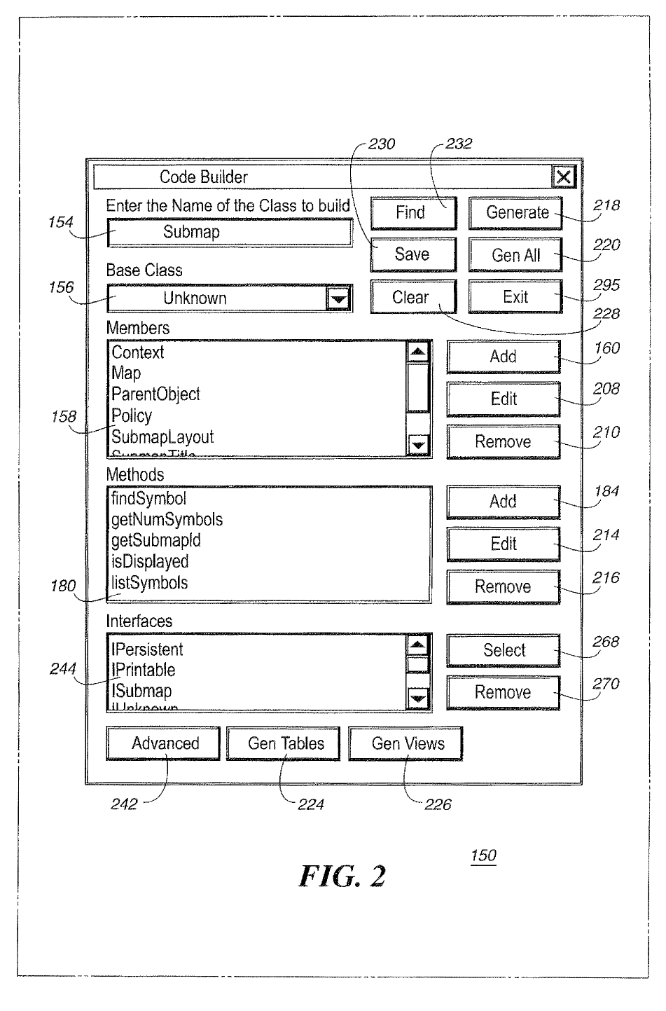

Consider now the entry of the meta data used in connection with the present invention. Such information representing the meta data is input via the GUI such as illustrated in FIGS. 2-6. FIG. 2 shows an exemplary main dialog for the graphical user interface of the code builder of the present invention illustrated as 150.

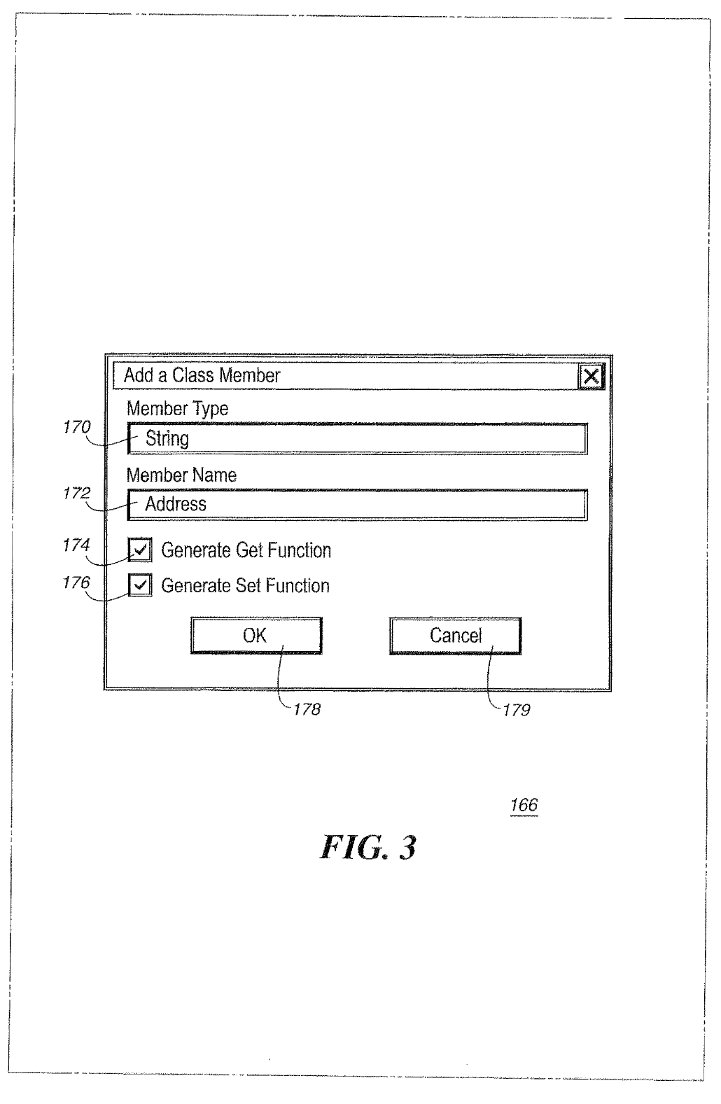

The use of main dialog 150 will be somewhat self-explanatory to those skilled in the art, with navigation of the dialogs to follow generally being accomplished by pointing to and selecting “buttons” or “icons” using a mouse or other computer pointing device to move a pointer or cursor over the desired portion of the dialog. However, by way of explanation, when a user wishes to build a class, the name of the class is entered in text box 154. The user can select the base class for the class in box 154 by operating a drop down dialog in a conventional manner to provide a selection of base classes in box 156. These base classes may include base classes already stored in the common object repository. Alternatively, the base class can be entered into box 156 directly by typing in the name of the base class. The user can then proceed to add members which will appear in text box 158 by selecting the “Add” button 160. This calls up the dialog 166 of FIG. 3 that permits the user to enter a member type in text box 170 and a member name in text box 172.

The user can also select whether to generate a “Get” function by checking box 174 (e.g., by “clicking” on the box with a mouse) or generate a “Set” function by checking box 176. When complete, the user selects the “OK” button 178. The dialog 166 can be terminated to return to main dialog 150 at any time by operating the “Cancel” button 179.

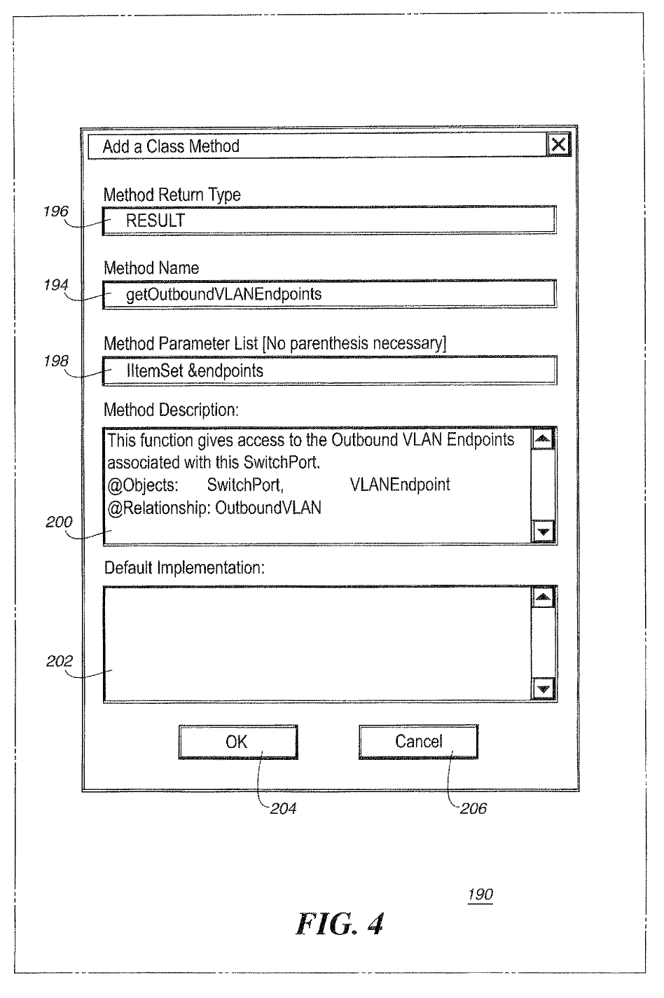

Referring back to FIG. 2, methods can similarly be generated to appear in text box 180 by selecting the “Add” button 184 to pull up a dialog 190 as shown in FIG. 4. In this dialog 190, the user specifies a method name at text box 194 along with a method return type at 196 and a parameter list for the method at 198. Additionally, the user provides a description of the method to assist in documentation of the code at 200 and can specify a default implementation if one exists at 202. When this information is completed, the user returns to the main dialog by selecting the “OK” button 204 or can abort this dialog in favor of the main dialog 150 by use of the “Cancel” button 206.

Referring now back to FIG. 2, “Edit” button 208 can be used to edit existing members appearing in text box 158 while “Remove” button 210 can be used to remove numbers. Those skilled in the art will appreciate that any suitable editing and deletion interfaces can be utilized to accomplish the function of buttons 208 and 210. Similarly, methods can be edited and removed using buttons 213 and 216 respectively.

When the user is ready to build the class, the “Generate” button 218 can be selected, for example by clicking with a mouse. To generate all classes, the user may select button 220. Database Tables can be generated by selecting button 224 while Database Views are generated by selection of button 226. “Clear” button 228 clears the current screen, “Save” button 230 saves the current screen and associated definitions while “Find” button 232 is used to invoke a search to find a class from the name currently entered in 154 using conventional string searching.

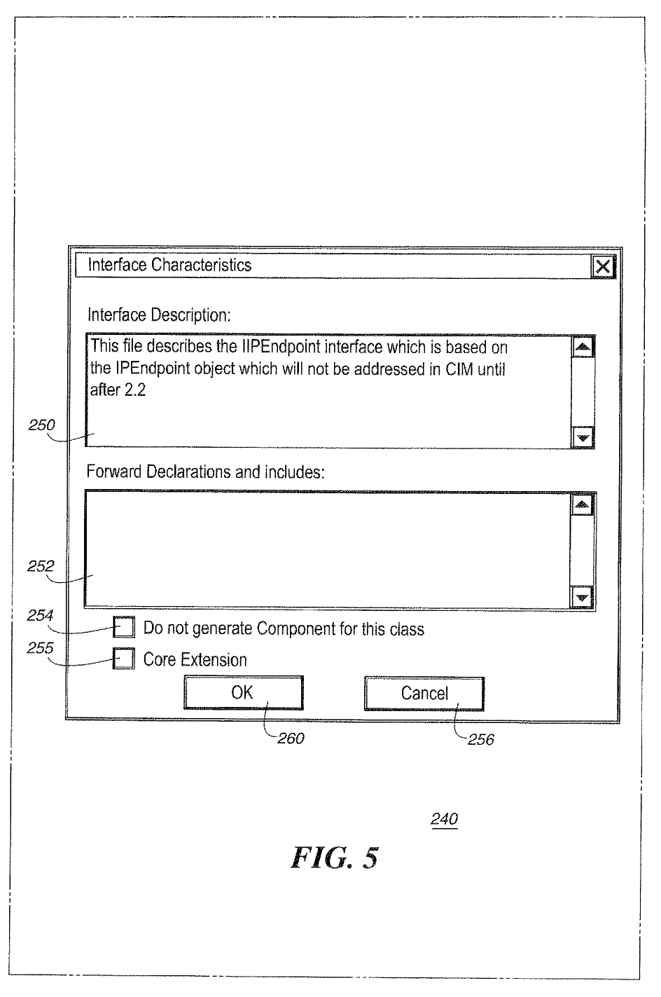

Referring to FIG. 5, interface characteristics can be input by use of dialog 240, which may be accessed by selection of the “Advanced” button 242 of the main dialog 150. Interface descriptions can be provided by entry of the description into text window 250 and forward declarations may be made using text box 252. In addition, the user can determine whether or not to generate a component object for this class by checking box 254 and whether it is a core extension by checking box 255. (A core extension is an externally loadable object not in the common object repository library. Most objects are expected to be core extensions, but this should not be considered limiting.) The operation can be cancelled by the “Cancel” button 256 or completed normally by selecting button 260.

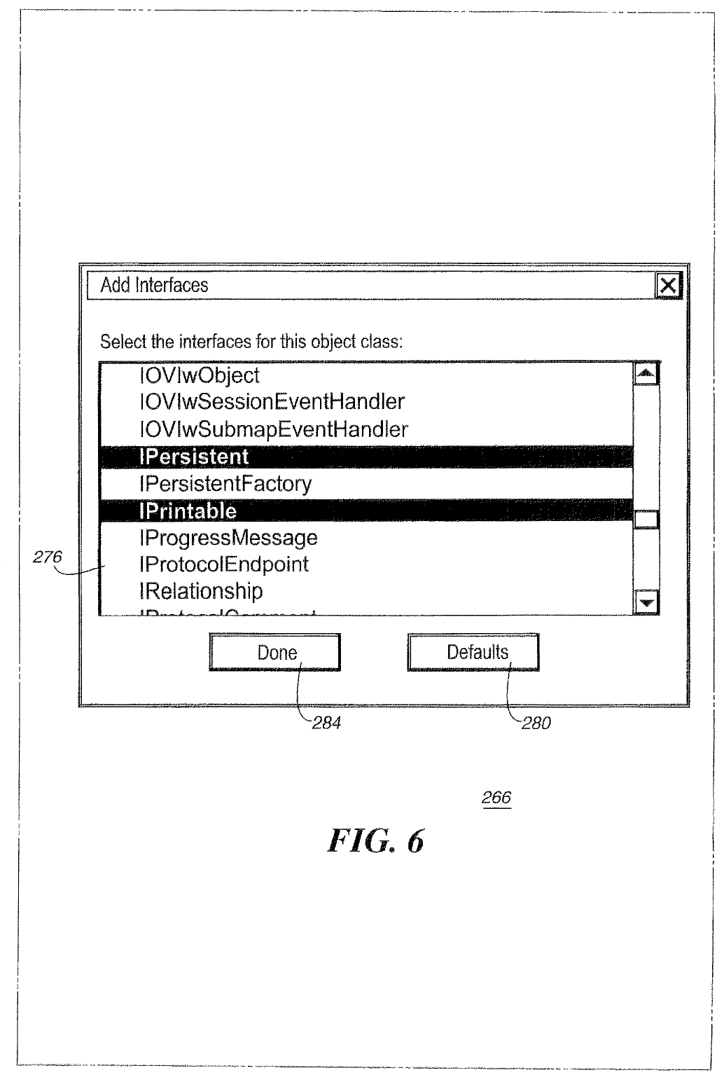

Referring to FIG. 6, interfaces can be added by use of dialog 266 by selecting an interface to add using “Select” button 268 of dialog 150. Button 270 of dialog 150 is used to delete a selected interface. Box 276 is used to display available interfaces from the common object repository and select those desired. A set of default interfaces can be chosen from the common object repository by selecting button 280. The “Done” button 284 is selected when the process is completed. The program can be exited at any time using the “Exit” button 195 of interface 150.

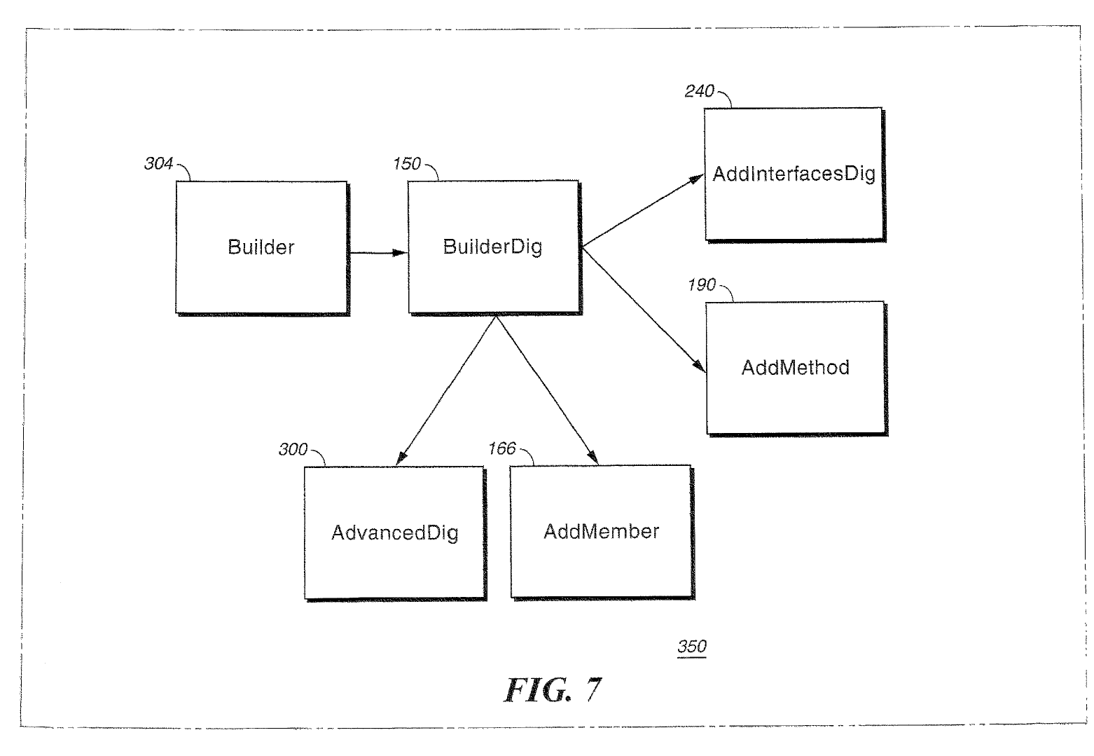

Referring now to FIG. 7, diagram 350 illustrates how the classes in the source code of the code builder program instantiate dialogues. Block 304 represents the main program of the code builder application. Upon starting the code builder application 304, the application (referred to as “builder”), the main dialog or menu 150 is created. The user selection from main dialog 150 causes the instantiation of either the “add member” dialog 166, “add method” dialog 190, “add interfaces” dialogue 240 or the “advanced dialogue” 300.

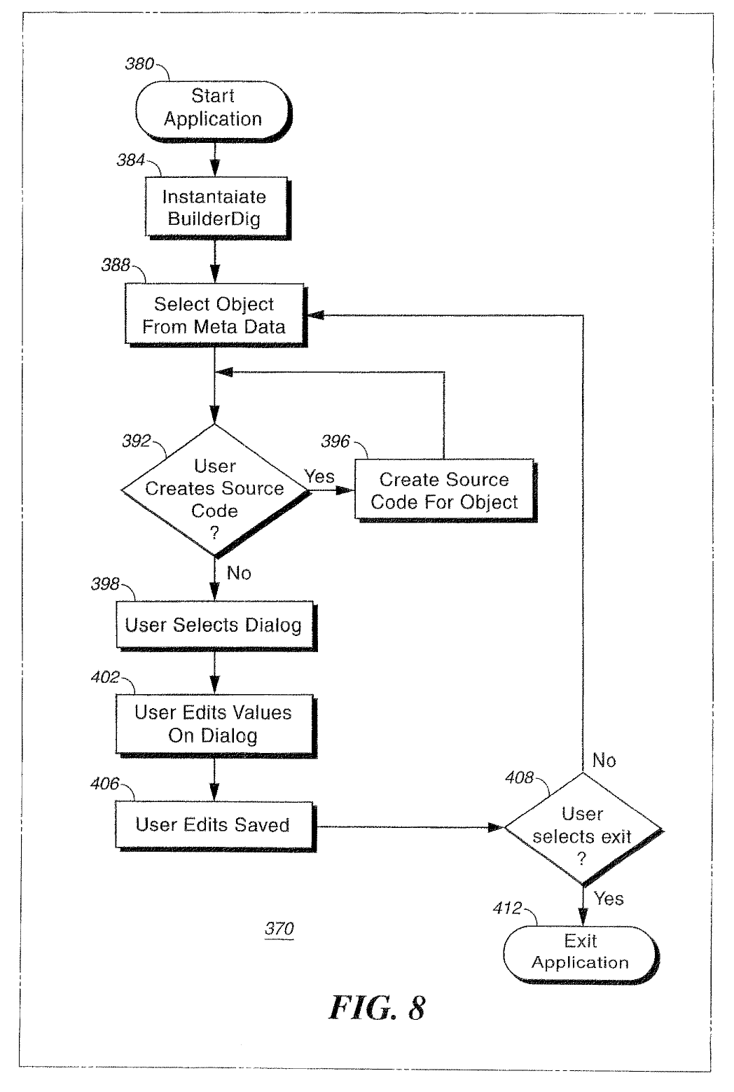

Referring now to FIG. 8, process 370 illustrates how the user interacts with the code builder tool 100 of the present invention starting at 380 where the code builder application is started. At 384 the builder dialogue 150 is instantiated to bring dialog 150 to the users display. The user selects an object from the meta data at 388 and control passes to 392 where the user determines if the source code is to be created for the object. If the user chooses to create source code at this point (392), the source code is created at 396. When the creation of source code is completed at 396 or if the user chooses not to create source code at 392, the user selects an appropriate dialogue at 398. The user can then edit values on the dialogue at 402 and save those edits at 406. If the user does not elect to exit at 408, control returns to 388. The process starting at 388 then repeats until the user elects to exit at 408 at which point the application exits at 412.

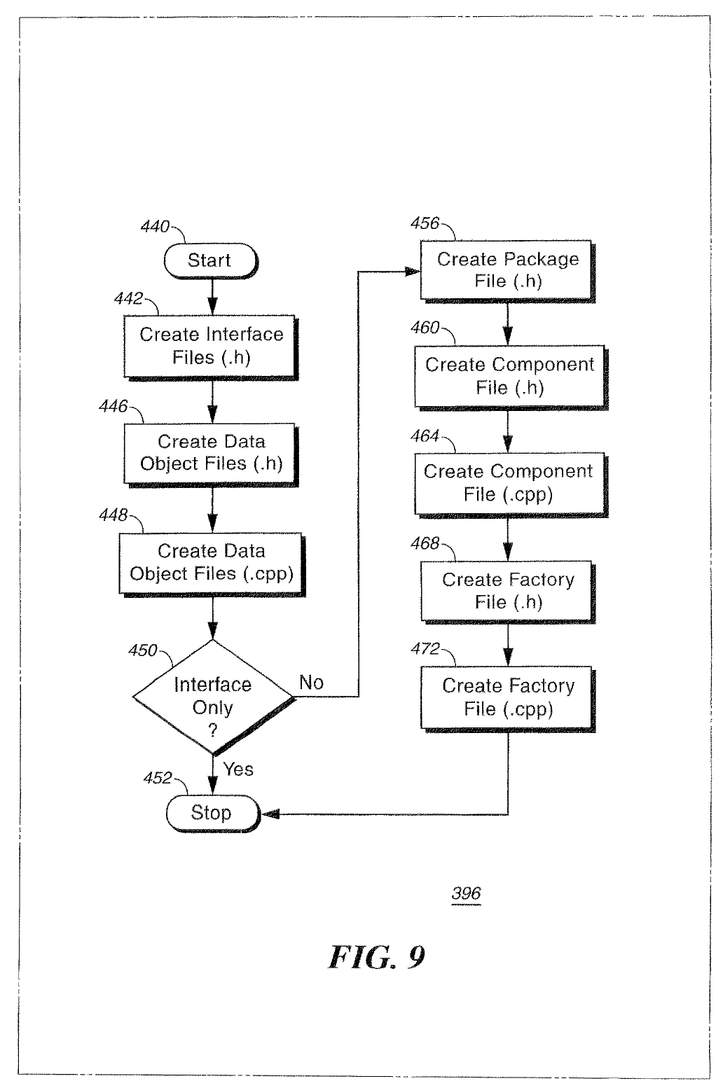

When the user elects to create source code files at 396, process 396 of FIG. 9 is carried out starting at 440. At 442 interface header files are created and stored as a part of a systematic hierarchy of files using any suitable file storage arrangement. At 446 data object header files are created and stored. At 448, data object implementation files are created and stored. If at 450 the source code creation is for an interface only, control passes to 452 where the source code creation process 396 terminates.

In the event the source code being created is not for only an interface, control passes to 456 where package header files are created and stored. At 460 component header files are created and stored. At 464 component implementation files are created and stored. At 468 factory header files are created and stored and at 472 factory implementation files are created and stored before the process terminates at 452. Those skilled in the art will recognize that the process just described can be carried out in other orders without departing from the invention. Moreover, hereinafter, reference to creation of a file should also imply that the file is stored in a systematic manner for easy retrieval, preferably using a hierarchical storage system.

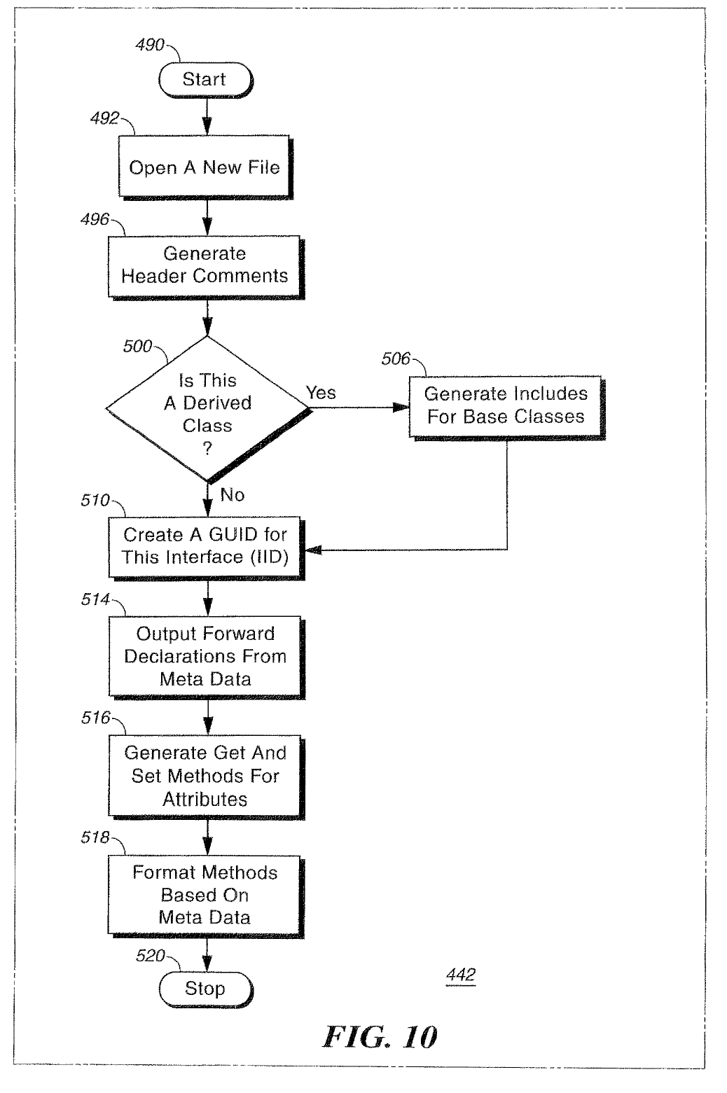

A more detailed explanation of the creation of the various files created in process 396 of FIG. 9 is now described in connection with FIGS. 10-17. In each case below, a set of standard rules is used to generate the desired code in accordance with an organization's code generation and naming standards. By use of standardized naming conventions and the like, the generation of the code becomes a mechanical task (e.g., implemented as a sequence of print statements wrapped with appropriate logic as defined by the decision blocks shown in the flow charts to follow, and using the meta data as variable data in the code) well suited to automation upon entry of the meta data defining functions and relationships between the objects, methods, etc. The process 442 of creating interface header files is described in detail in connection with FIG. 10 starting at 490. At 492 a new file is opened (an interface header file containing the basic interface definition) and header comments are generated at 496. The header file comments can include fixed code to be used in each file (e.g., a copyright notice, project name, and the like) as well as data provided as a part of the meta data (e.g., the interface description or other information derived from the meta data).

If the current class is a derived class at 500, as indicated by the meta data, “include” statements are generated for each of the base classes at 506. The term ‘“include” statements’ as used herein is intended to embrace not only literal “include” statements forming a part of the C++ programming language, but also similar programming statements and constructs that perform similar functions of referencing other interfaces and base classes to specify dependency as provided for in any suitable object oriented programming language, without limitation. The “include” statements can be generated by repeated use of a “print” statement for each base class input as a part of the meta data as represented by the pseudo-code below:

...
IF “Base_Class” NOT EQUAL TO “nul” THEN

FOR EACH Base_Class
PRINT “< Include Header files for all base classes

>”

NEXT Base_Class

...

If the current class is not a derived class at 500, control passes directly to 510. If “include” statements are generated at 506 control then passes to 510. At 510, a GUID (Globally Unique Identifier) or UUID (Universally Unique IDentifier) is created for the current interface (the terms UUID and GUID may be used somewhat interchangeably herein to designate an identification that is unique throughout the current software system). Forward declarations are then output at 514 from the meta data. At 516 “Get” and “Set” methods are generated for the user defined attributes and at 518 the methods are formatted based on the meta data. The process ends at 520. The “Get” and “Set” methods can be generated and formatted according to the following pseudo-code:

...
for each attribute in metaData{}

if (attribute.shouldHaveGetMethod == true){

outputGetMethod (attribute)

}

if (attribute.shouldHaveSetMethod == true){

outputSetMethod (attribute)

}
. . .

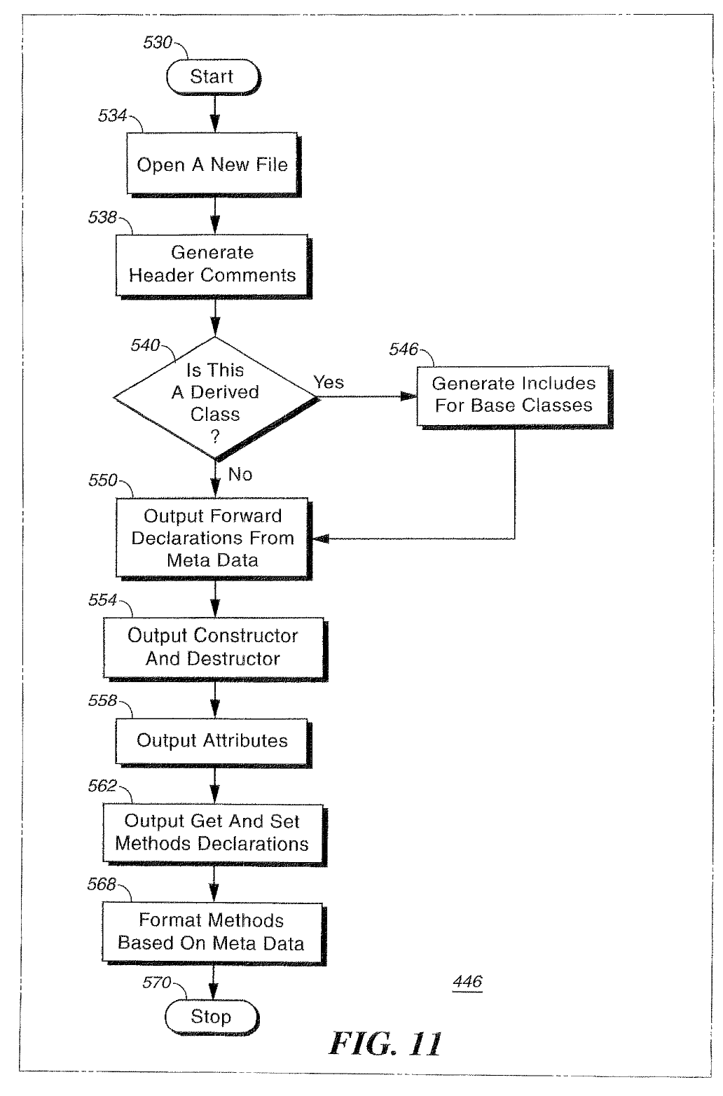

Referring now to FIG. 11, the process of generating data object header files at 446 is illustrated starting with 530. At 534 a new file is opened and header comments are generated at 538. If the current object is a derived class at 540, control passes to 546 where “include” statements are generated to provide reference to and inheritance from the base classes. Control then passes to 550 from either 540 or 546 where forward declarations are generated and output from the meta data supplied by the user. At 554 constructors and destructors (methods that create or destroy an object instance when no longer needed) are output and at 558 attributes are output. At 562 “Get” and “Set” method declarations are generated, and at 568 the methods are formatted based on the meta data with the process ending at 570. The constructors and destructors can be generated according to the following pseudocode:

. . .

//outputConstructor

print objectName

print “( ){“

outputConstructorContents( )

print “}”

print “ ”

//outputDestructor

print”˜”

print objectName

print “( ){“

outputDestructorContents( )

print “}”

. . .

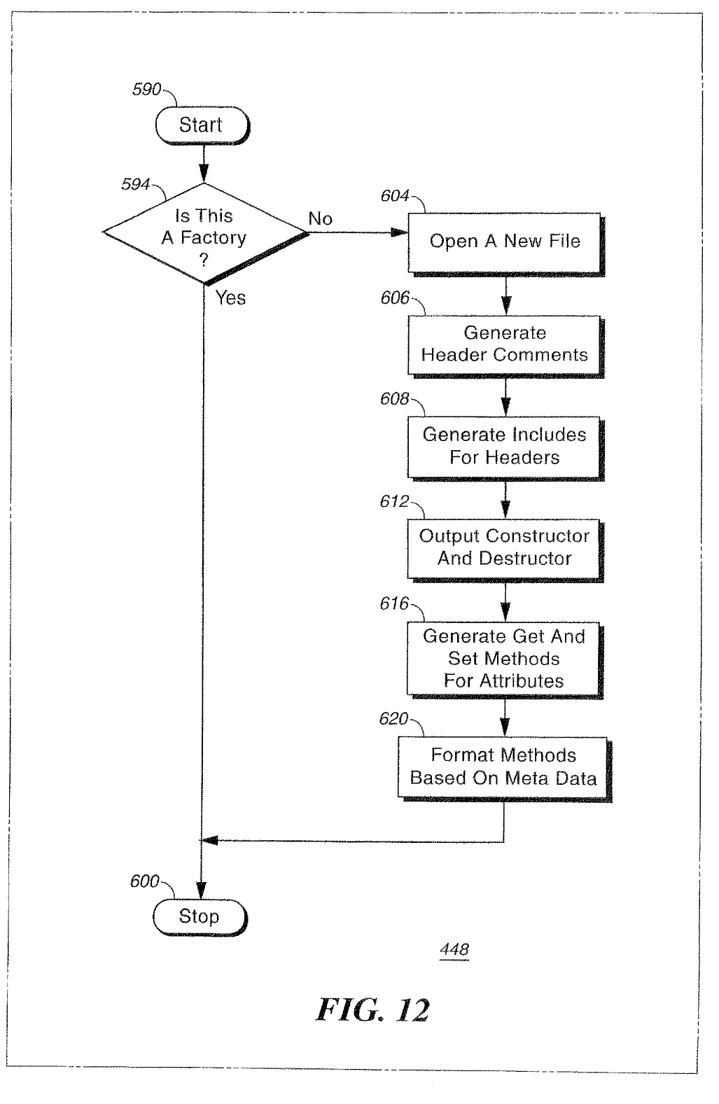

Data object implementation files are created in accordance with 448 as illustrated in FIG. 12 starting at 590. If the object is a factory at 594, the process immediately terminates at 600. Otherwise, a new file is opened at 604 with header comments being generated at 606. “include” statements are generated for the headers at 608 and constructors and destructors are output at 612. “Get” and “Set” methods are generated at 616 for the attributes and the methods are formatted based on the meta data supplied by the user at 620. The process then terminates at 600.

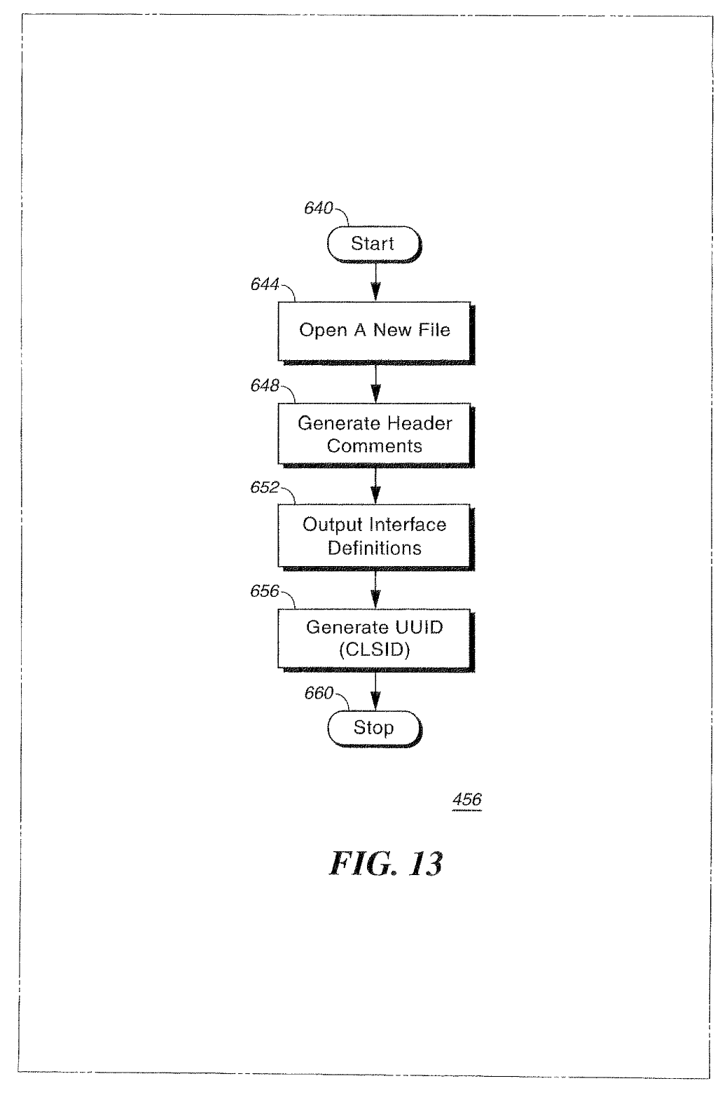

FIG. 13 depicts the process of 456 wherein the package header file is created starting at 640. At 644 a new file is opened with header comments generated at 648. The interface definitions are output at 652. The UUID and (CLSID—Class ID—used to refer to the package) are generated at 656 and then the process terminates at 660. The UUID may be generated by a call to a routine that generates unique identification numbers using any suitable publicly available UUID number generation algorithm. In other embodiments, a unique identifier can be created using any suitable technique(e.g., sequentially or randomly).

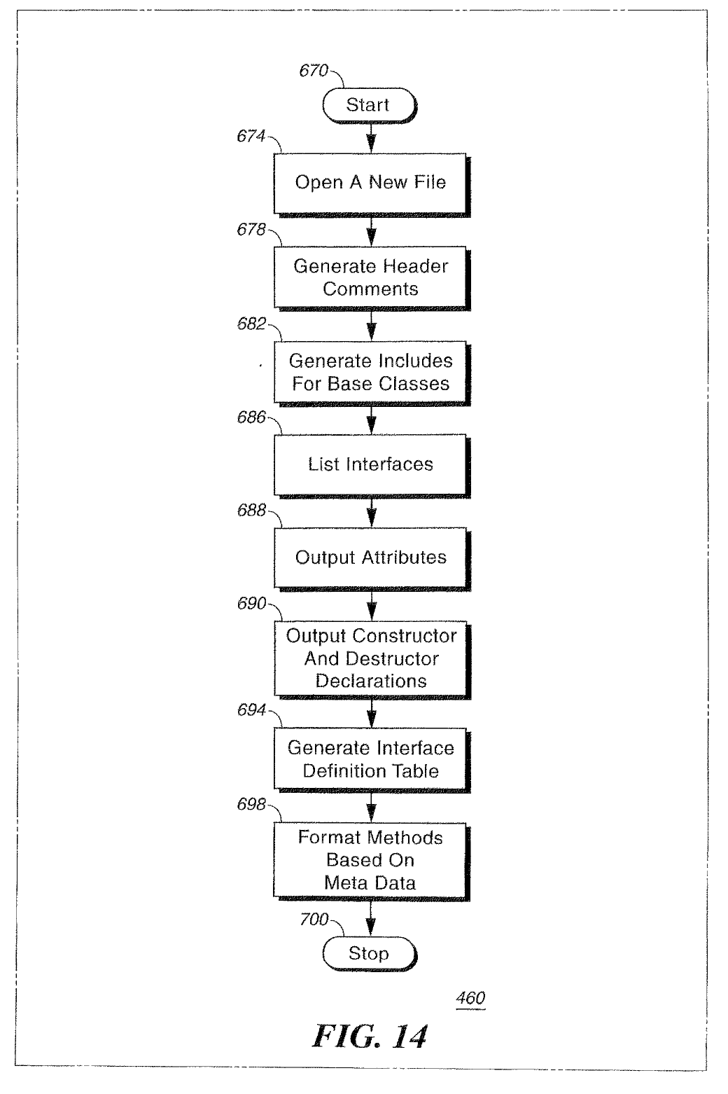

Referring now to FIG. 14, the process 460 of creation of component header files starts at 670 with a new file being created at 674. Header comments are created at 678 and at 682 “include” statements are generated for the base classes. The interfaces are listed at 686 and attributes are output at 688. At 690 the constructor and destructor declarations are output to appropriately construct and destroy the instances. An interface definition table is generated at 694 and the methods are formatted based on meta data supplied by the user at 698. The process ends at 700.

The interface definition table is a segment of code that enumerates all of the interfaces supported by a given component. In the current embodiment, the interface definition table is implemented as described in “Essential COM”, by Don Box, Addison-Wesley, 1998. This text describes the table as an “interface table” and an appropriate technique for creation of such a table is described in detail in chapter 2 thereof. This text is hereby incorporated by reference as though disclosed fully herein.

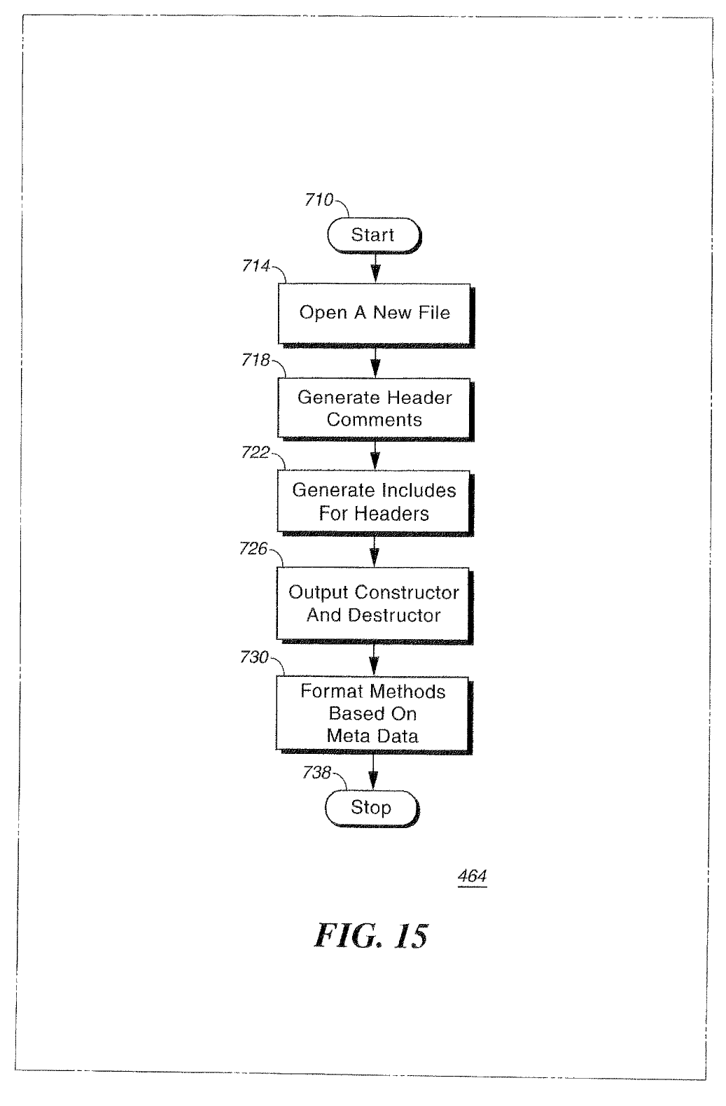

Referring now to FIG. 15, process 464 of creating component implementation files starts at 710. A new file is created at 714 with header comments generated at 718. At 722, “include” statements are generated for the headers. At 726 constructors and destructors are output and at 730 methods are formatted based on the meta data supplied by the user. The process then ends at 738.

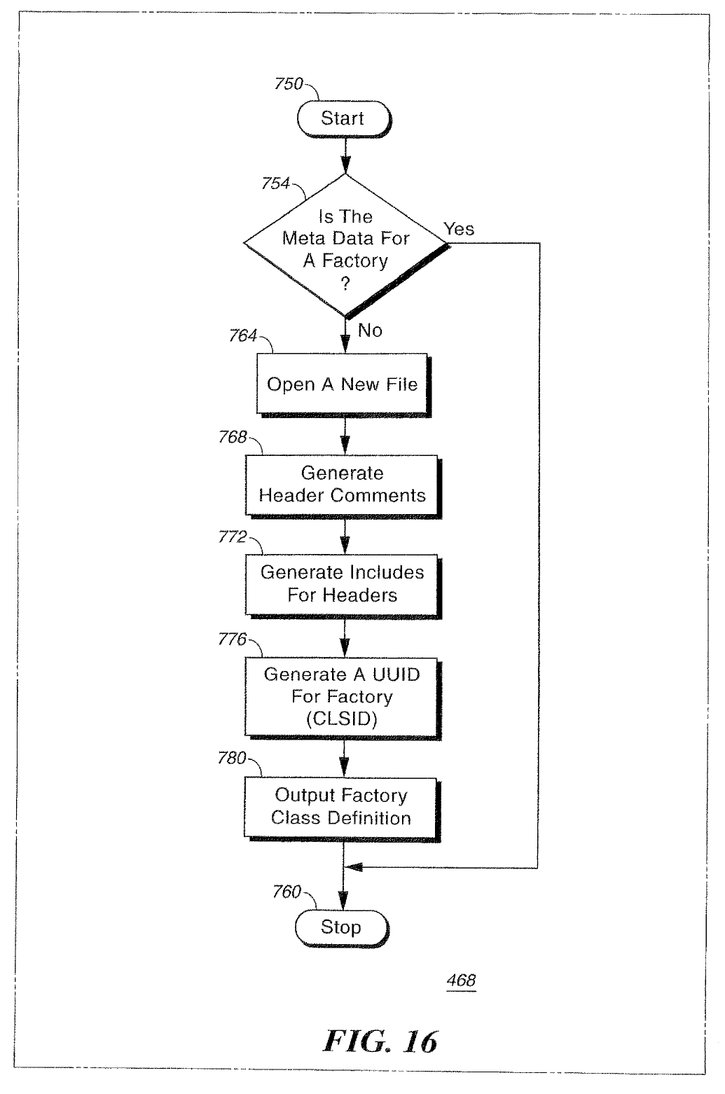

Referring now to FIG. 16, the process 468 of creating a factory header file starts at 750. If at 754 the meta data is for a factory, control passes directly to 760 where the process terminates (so that meta data can be entered about factories, without actually creating a factory that creates a factory). Otherwise, a new file is opened at 764 and header comments are generated at 768. “include” statements are generated for the headers at 772 and UUID is generated for a factory at 776. The factory class definition is then output at 780 and the process ends at 760.

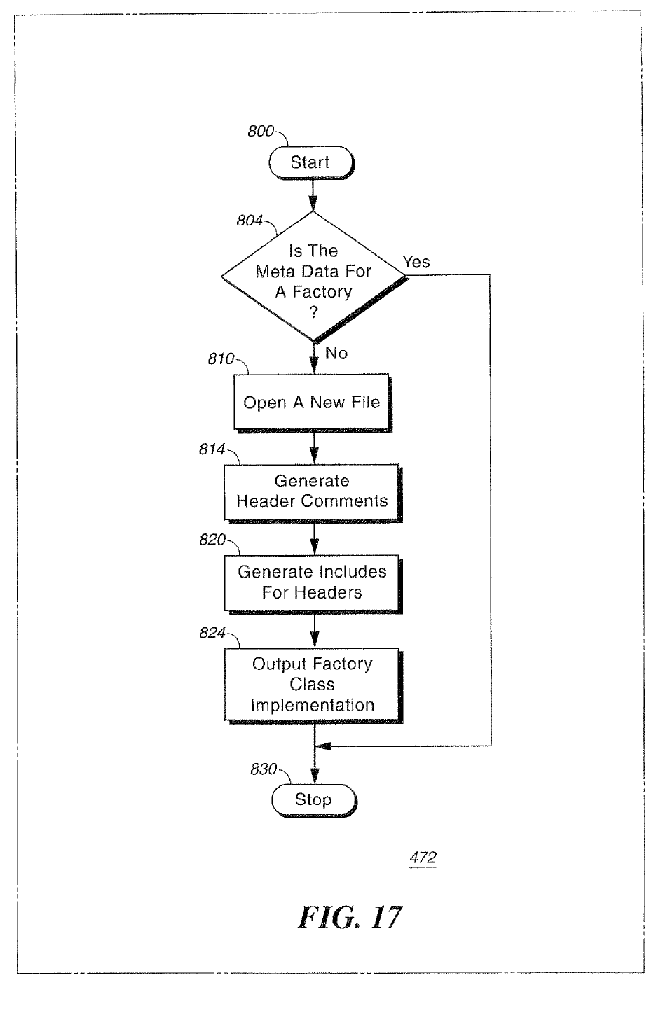

Referring now to FIG. 17, the process 472 of creating the factory implementation file starts at 800. If at 804, the meta data is for a factory, the process terminates at 830. Otherwise, a new file is opened at 810, header comments are generated at 814 and “include” statements are generated for the headers at 820. The factory class implementation is output at 824 and the process terminates at 830.

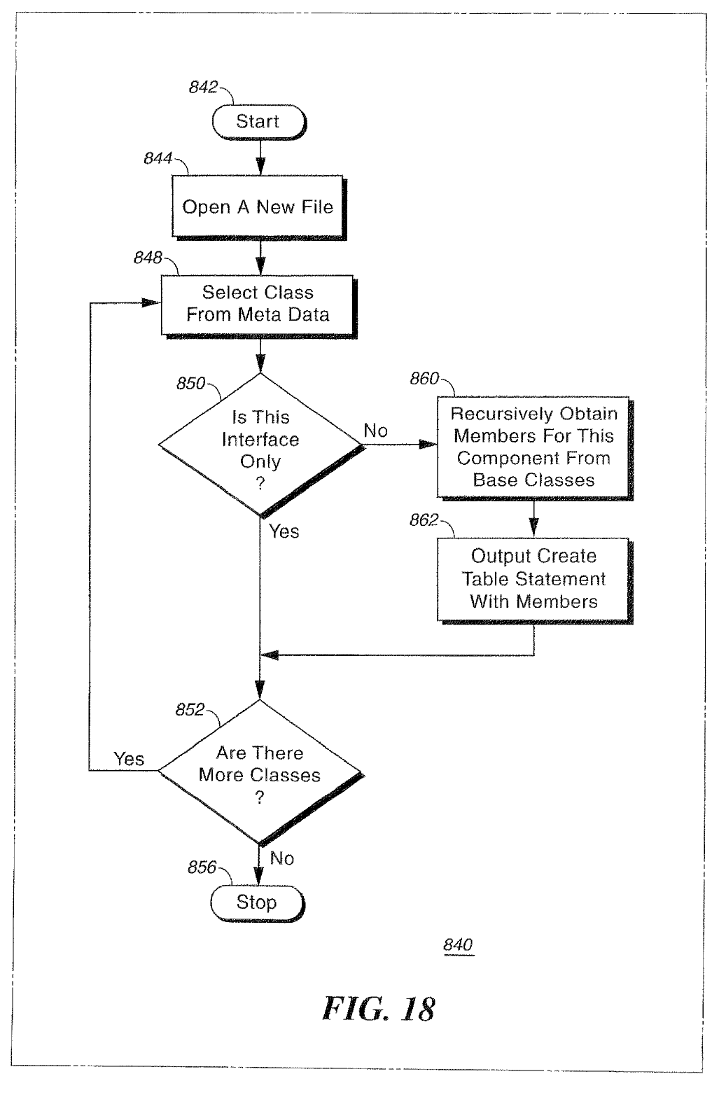

Referring now to FIG. 18, a flow chart 840 describes creating an SQL Table File according to an embodiment consistent with the present invention starting at 842. At 844, a new file is opened and a class is selected from the meta data at 848. If the meta data indicates an interface only, at 850, and there are no more classes at 852, process 840 terminates at 856. If the meta data does not indicate interface only, control passes to 860 where members for the current component are recursively obtained from the base classes. At 862, “Create Table” statements are output (e.g., as in the code shown as LISTING 1) with members as the target and control passes to 852. If there are more classes at 852, control returns to 848. Otherwise, the process terminates at 856. Creation of SQL tables, in accordance with the flow charts of FIGS. 18-21 can be accomplished in a manner similar to that used to create the C++ files by use of “Print” statements in conjunction with appropriate logical decisions as described previously.

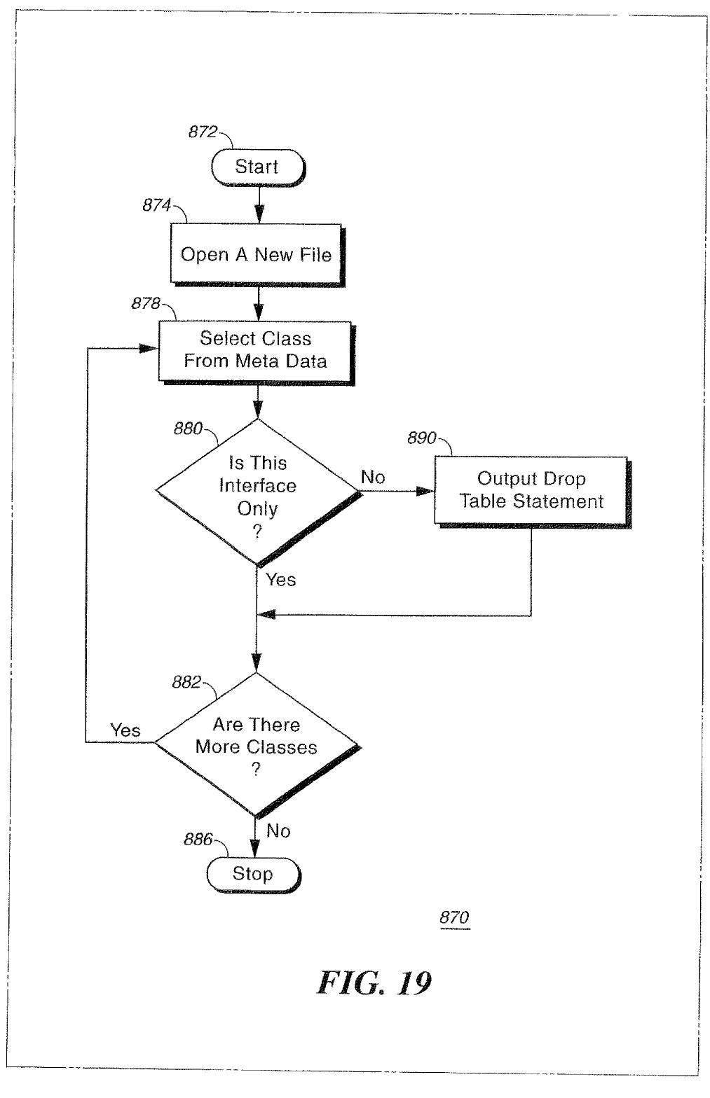

Referring now to FIG. 19, a flow chart 870 describes creating an SQL Table Removal File according to an embodiment consistent with the present invention starting at 872. At 874, a new file is opened and a class is selected from the meta data at 878. If the meta data indicates an interface only, at 880, and there are no more classes at 882, process 870 terminates at 886. If the meta data does not indicate interface only, control passes to 890 where a “Drop Table” statement is output, and control passes to 882. If there are more classes at 882, control returns to 878. Otherwise, the process terminates at 886.

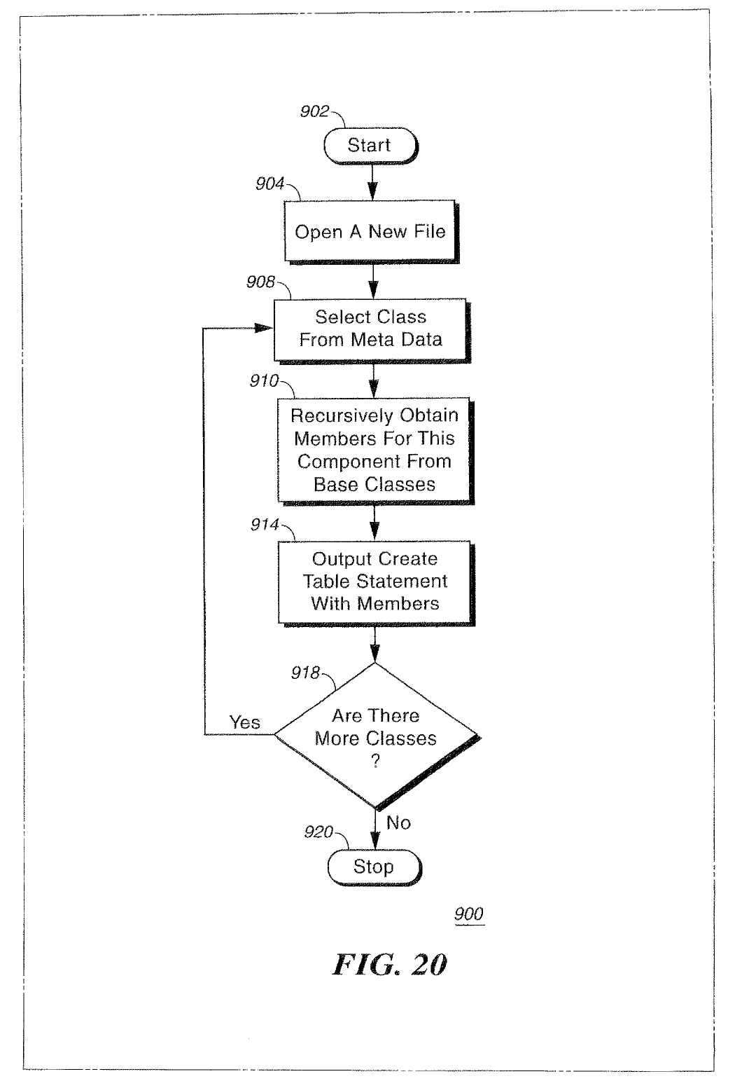

Referring now to FIG. 20, a flow chart 900 describes creating an SQL View file according to an embodiment consistent with the present invention starting at 902. At 904, a new file is opened and a class is selected from the meta data at 908. Control passes to 910 where members for the current component are recursively obtained from the base classes. At 914, “Create View” statements are output with members as the target and control passes to 918. If there are more classes at 918, control returns to 908. Otherwise, the process terminates at 920.

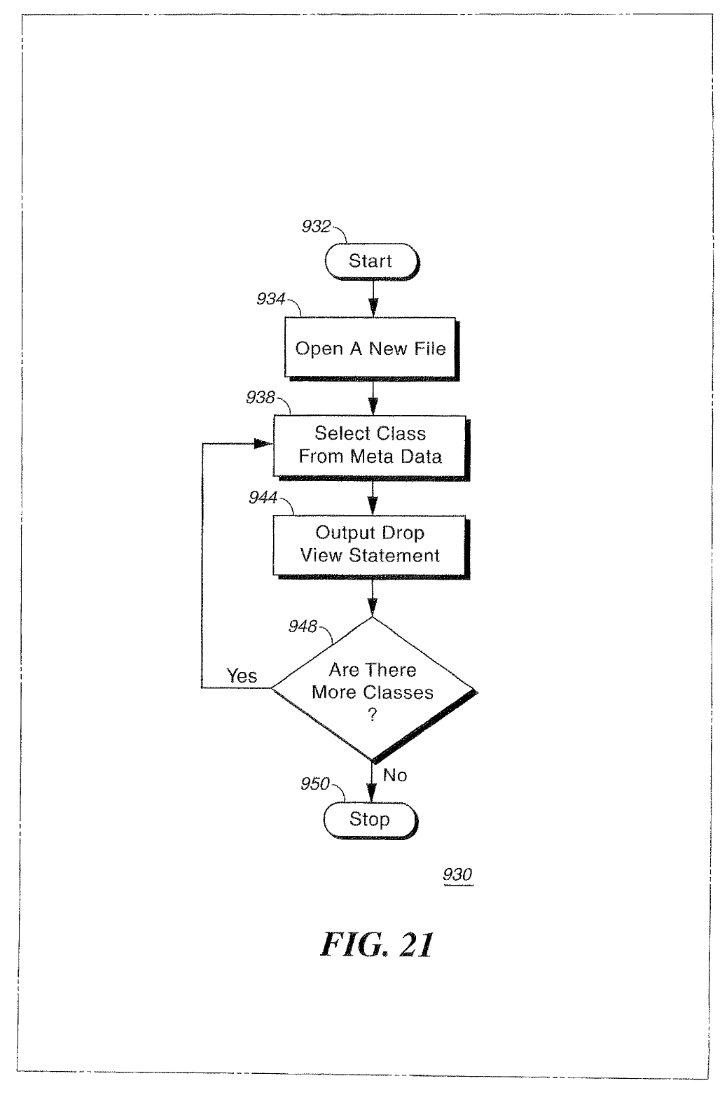

Referring now to FIG. 21, a flow chart 930 describes creating an SQL View Removal File according to an embodiment consistent with the present invention starting at 932. At 934, a new file is opened and a class is selected from the meta data at 938. At 944, a “Drop View” statement is output with members and control passes to 948. If there are more classes at 948, control returns to 938. Otherwise, the process terminates at 950.

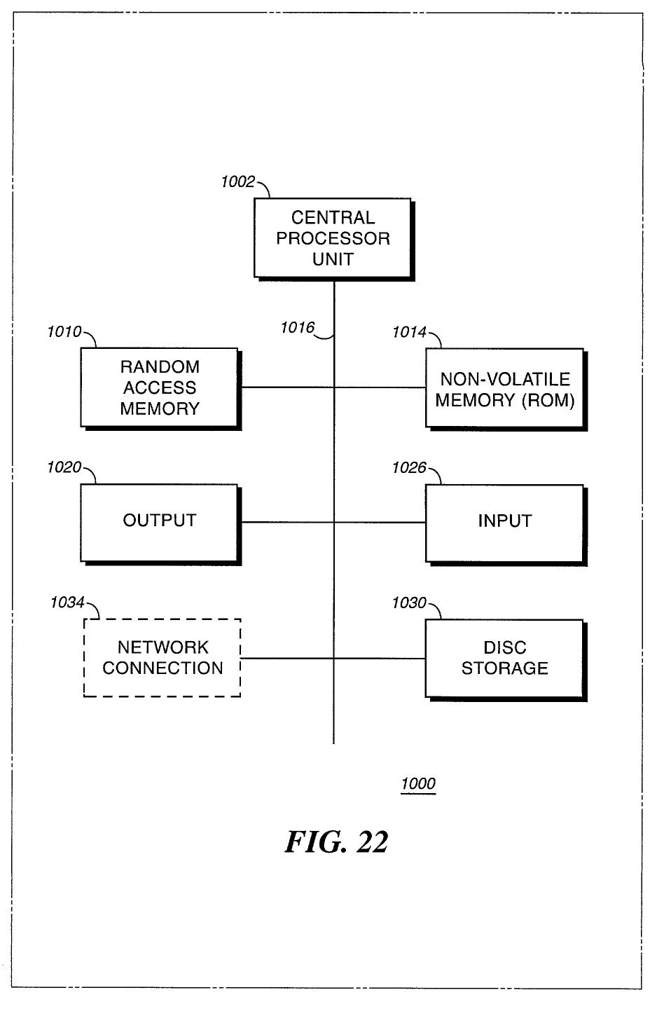

Referring now to FIG. 22, a computer system suitable for running the code creation application of the present invention is illustrated as 1000. A central processor 1002 is coupled via one or more buses 1006 to Random Access Memory (RAM) 1010 and non-volatile memory such as Read Only Memory (ROM) 1014. An output device such as a display monitor 1020 is provided to display the user interface as described and otherwise provide relevant information and feedback to the user. One or more input devices such as keyboard, mouse, etc. is provided a 1026. Disc storage devices 1030 are provided for storing the code building application as well as the resulting code. The computer system 1000 may also include a network connection 1034 to one or more other peer, server or client computers.

A prototype of this invention was created on Microsoft Corporation's Windows NT operating system, version 4.0, service pack 4, using Microsoft Corporation's Visual C++ version 5.0 and Solid Version 2.3 and generates code that compiles on NT 4.0, HPUX 11.0 and Solaris 2.6. This invention increases the consistency of the code generated to represent a complex object model. This results in less defects per line of code, as well as greater supportability of a code stream. It also allows the engineer to work at a higher level of abstraction, which results in greater productivity.

Use of the present code generation tool increases code consistency resulting in better supportability and produces a better defects per line of code ratio. A prototype of the current code generator tool of the preferred embodiment of the present invention has been found capable of generating thousands of lines of code that represent complex object models in seconds in contrast to the many man-weeks that would otherwise be required, thus greatly decreasing the engineering staff required to create a multi-platform common object repository.

Those of ordinary skill in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention. Such alternatives should be considered equivalents.

The present invention is preferably implemented using a programmed processor executing programming instructions that are broadly described above in flow chart form and which can be stored in any suitable electronic storage medium. However, those skilled in the art will appreciate that the processes described above can be implemented in any number of variations and in many suitable programming languages without departing from the present invention. For example, the order of certain operations carried out can often be varied, and additional operations can be added without departing from the invention. Error trapping can be added and/or enhanced and variations can be made in user interface and information presentation without departing from the present invention. Moreover, while the above exemplary embodiment is described in terms of use of the C++ Object Oriented programming language and use of SQL compliant relational database tables, the invention can be equally applied to use of Java, SmallTalk and other Object Oriented programming languages as well as non-SQL compliant database tables. Such variations are contemplated and considered equivalent.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A method of automating generation of object oriented code, comprising:
receiving meta data defining an object and the object's relationships;
creating source code from the meta data, the source code defining the object and the object's relationships;
creating a storage definition for the storage of an instantiation of the object using the meta data; and
storing the storage definition in a common object repository.

2. The method according to claim 1, further comprising:
instantiating the object using the source code; and
storing the instantiation of the object in the common object repository.

3. The method according to claim 1, wherein the meta data is stored in a database table.

4. The method according to claim 1, wherein the storage definition is stored in a database table.

5. The method according to claim 1, wherein creating the source code further comprises:
creating an interface header file from the meta data;
creating a data object header file from the meta data; and
creating a data object implementation file from the meta data.

6. The method according to claim 5, wherein creating an interface header file from the meta data comprises:
creating a file;
generating header comments;
If the class is a derived class, as indicated by the meta data, then:
generating an “include” statement for base classes;
creating a globally unique identifier for the current interface;
outputting forward declarations from the meta data;
generating “Get” and “Set” methods; and
formatting the methods based on the meta data.

7. The method according to claim 5, wherein creating a data object header file from the meta data comprises:
creating a file;
generating header comments;
if the object is a derived class, generating an “include” statement for a base class;
generating forward declarations from the meta data;
generating constructors and destructors;
generating “Get” and “Set” method declarations; and
formatting methods based on the meta data.

8. The method according to claim 5, wherein creating a data object implementation file from the meta data further comprises:
if the object is not a factory opening a file;
generating header comments;
generating “include” statements for a header;
generating a constructor and a destructor;
generating a “Get” and a “Set” method; and
formatting a method based on the meta data.

9. The method according to claim 1, wherein if the object is an interface file, the creating the source code further comprises:
creating a package header file from the meta data;
creating a component header file from the meta data;
creating a component implementation file from the meta data;
creating a factory header file from the meta data; and
creating a factory implementation file from the meta data.

10. The method according to claim 9, wherein creating a package header file from the meta data further comprises:
creating a file;
outputting an interface definition; and
generating a Universally Unique IDentifier (UUID).

11. The method according to claim 9, wherein creating a component header file from the meta data comprises.
creating a file;
generating comments;
generating an “include” statement for a base class
listing interfaces;
outputting attributes;
outputting a constructor and a destructor declaration;
generating an interface definition table; and
formatting a method based on the meta data.

12. The method according to claim 9, wherein creating a component implementation file from the meta data comprises:
creating a file;
generating header comments;
generating an “include” statement;
outputting a constructor and a destructor; and
formatting a method based on the meta data.

13. The method according to claim 9, wherein creating a factory header file from the meta data comprises:
creating a file;
generating header comments;
generating an “include” statement;
generating a Universally Unique IDentifier (UUID); and
outputting a factory class definition.

14. The method according to claim 9, wherein creating a factory implementation file from the meta data comprises:
creating a file;
generating header comments;
generating an “include” statement; and
outputting a factory class implementation.

15. An electronic storage medium, storing instructions that, when executed on a programmed processor, carry out a method according to claim 1.

16. A method of automating generation of object oriented code for an object, comprising:
providing a common object repository storing a library of interrelated objects;
receiving meta data defining an object and the object's relationships with_objects stored in the common object repository;
creating source code from the meta data, the source code defining the object and the object's relationships;
creating a definition for the storage of an instantiation of the object using the meta data; and
storing the storage definition in the common object repository.

17. The method according to claim 16, further comprising:
instantiating the object using the source code; and
storing the instantiation of the object in the common object repository.

18. The method according to claim 16, wherein the meta data is stored in a database table.

19. The method according to claim 16, wherein the storage definition is stored in a database table.

20. The method according to claim 16, wherein creating the source code further comprises:
creating an interface header file from the meta data;
creating a data object header file from the meta data; and
creating a data object implementation file from the meta data.

21. The method according to claim 20, wherein creating an interface header file from the meta data comprises:
creating a file;
generating header comments;
If the class is a derived class, as indicated by the meta data, then:
generating an “include” statement for base classes;
creating a globally unique identifier for the current interface;
outputting forward declarations from the meta data;
generating “Get” and “Set” methods; and
formatting the methods based on the meta data.

22. The method according to claim 20, wherein creating a data object header file from the meta data comprises:
creating a file;
generating header comments;
if the object is a derived class, generating an “include” statement for a base class;
generating forward declarations from the meta data;
generating constructors and destructors;
generating “Get” and “Set” method declarations; and
formatting methods based on the meta data.

23. The method according to claim 20, wherein creating a data object implementation file from the meta data further comprises:
if the object is not a factory opening a file;
generating header comments;
generating “include” statements for a header;
generating a constructor and a destructor;
generating a “Get” and a “Set” method; and
formatting a method based on the meta data.

24. The method according to claim 16, wherein if the object is an interface file, the creating the source code further comprises:
creating a package header file from the meta data;
creating a component header file from the meta data;
creating a component implementation file from the meta data;
creating a factory header file from the meta data; and
creating a factory implementation file from the meta data.

25. The method according to claim 24, wherein creating a package header file from the meta data further comprises:
creating a file;
outputting an interface definition; and
generating a Universally Unique IDentifier (UUID).

26. The method according to claim 24, wherein creating a component header file from the meta data comprises.
creating a file;
generating comments;
generating an “include” statement for a base class
listing interfaces;
outputting attributes;
outputting a constructor and a destructor declaration;
generating an interface definition table; and
formatting a method based on the meta data.

27. The method according to claim 24, wherein creating a component implementation file from the meta data comprises:
creating a file;
generating header comments;
generating an “include” statement;
outputting a constructor and a destructor; and
formatting a method based on the meta data.

28. The method according to claim 24, wherein creating a factory header file from the meta data comprises:
creating a file;
generating header comments;
generating an “include” statement;
generating a Universally Unique IDentifier (UUID); and
outputting a factory class definition.

29. The method according to claim 24, wherein creating a factory implementation file from the meta data comprises:
creating a file;
generating header comments;
generating an “include” statement; and
outputting a factory class implementation.

30. An electronic storage medium, storing instructions that, when executed on a programmed processor, carry out a method according to claim 16.

31. An electronic storage medium, storing instructions that, when executed on a programmed processor, carry out a method of automating generation of object oriented code, comprising:
receiving meta data defining an object and the object's relationships;
creating source code from the meta data, the source code defining the object and the object's relationships;
creating a storage definition for the storage of an instantiation of the object using the meta data; and
storing the storage definition in a common object repository.

32. The electronic storage medium according to claim 31, further comprising:
instantiating the object using the source code; and
storing the instantiation of the object in the common object repository.

33. An electronic storage medium, storing instructions that, when executed on a programmed processor, carry out a method of automating generation of object oriented code, comprising:
providing a common object repository storing a library of interrelated objects;
receiving meta data defining an object and the object's relationships with_objects stored in the common object repository;
creating source code from the meta data, the source code defining the object and the object's relationships;
creating a definition for the storage of an instantiation of the object using the meta data; and
storing the storage definition in the common object repository.

34. The electronic storage medium according to claim 33, further comprising:
instantiating the object using the source code; and
storing the instantiation of the object in the common object repository.

35. A computer system, comprising:
a programmed processor;
storage means storing a common object repository containing a library of interrelated objects;
a user interface that receives meta data defining an object and the object's relationships with objects stored in the common object repository;
a program segment, running on the programmed processor, that functions to:
create source code from the meta data, the source code defining the object and the object's relationships;
create a definition for the storage of an instantiation of the object using the meta data; and
stores the storage definition in the common object repository.

36. The computer system according to claim 35, wherein the program segment further functions to:
instantiate the object using the source code; and
store the instantiation of the object in the common object repository.

37. The computer system according to claim 35, further comprising a relational database operating on the programmed processor, and wherein the meta data is stored in relational database tables.

38. The computer system according to claim 35, further comprising a relational database operating on the programmed processor, and wherein the storage definition is stored in a relational database table.
